(19) United States
(12) Patent Application Publication
(10) Pub. No.: US 2013/0110377 A1
(43) Pub. Date: May 2, 2013

(54) Fuel Injection Apparatus for Internal Combustion Engine

(71) Applicant: Hitachi Automotive Systems, Ltd., Hitachinaka-shi (JP)

(72) Inventors: Yoshihiro SUKEGAWA, Hitachi (JP); Tomoyuki Murakami, Isesaki (JP); Masayuki Saruwatari, Isesaki (JP); Kosuke Kanda, Isesaki (JP)

(21) Appl. No.: 13/660,406

(22) Filed: Oct. 25, 2012

(30) Foreign Application Priority Data
Oct. 28, 2011 (JP) 2011-236604

(51) Int. Cl. F02D 41/34

(52) U.S. Cl. 701/103

(57) ABSTRACT

A fuel injection apparatus for an internal combustion engine of port injection type is configured to change a ratio between a fuel injection period in an exhaust stroke and one in an inlet stroke in accordance with an internal EGR rate.

### BACKGROUND OF THE INVENTION

The present invention relates to a fuel injection apparatus for an internal combustion engine of port injection type for enhancing the combustion efficiency at a high EGR rate.

Exhaust gas recirculation (EGR) is known as effective measures for improving the efficiency in fuel consumption in an internal combustion engine of spark ignition type. The EGR can attain effects such as reduction in pumping loss within light and middle load operation areas, improvement in thermal efficiency by rise in the ratio of specific heats, reduction in thermal loss by reduced combustion temperature and the like. Generally, these effects can be obtained more highly as the EGR amount is increased and accordingly the technique of introducing large volume of the EGR by the variable valve train control or the like spreads.

Incidentally, EGR gas contains N₂ and CO₂ as main components and does not contain oxygen. Accordingly, when EGR in large volume is introduced, it is apprehended that the concentration of oxygen around fuel molecules is lowered and imperfect combustion is caused. The imperfect combustion causes increase of detrimental components (CO, HC) in the exhaust gas and deterioration of fuel consumption. Accordingly, even when the EGR in large volume is introduced, it is required to make combustion satisfactorily. For this reason, the technique of stratifying EGR gas, fresh air and fuel within a combustion chamber and producing a mixture so that the concentration of oxygen around fuel is not reduced is described in JP-A-6-213080 (U.S. Pat. No. 5,379,743). In this technique, an exhaust port and an inlet port are disposed so that unidirectional swirl flow is formed within the combustion chamber and an inlet valve and an exhaust valve are connected to be operated by respective variable timing mechanisms. In the inlet stroke, the exhaust valve is first opened to re-suck exhaust gas into the combustion chamber. Then, the exhaust valve is closed and the inlet valve is open to thereby suck fresh air and fuel into the combustion chamber. Consequently, the EGR gas is positioned on the lower side of the combustion chamber and fresh air and fuel are positioned on the upper side to be stratified.

### SUMMARY OF THE INVENTION

It is an object of the present invention to suppress imperfect combustion even when EGR gas is introduced.

In order to solve the above problem, according to the present invention, a fuel injection apparatus for an internal combustion engine including means for injecting fuel into an inlet port and presuming an internal EGR rate changes a ratio between a fuel injection period in an exhaust stroke and one in an inlet stroke in accordance with the internal EGR rate presumed by the presumption means of the internal EGR rate. Further, presumption of the EGR rate can be made by length of a valve overlap period.

The vaporization characteristic of fuel is excellent in injection of fuel in the exhaust stroke, while the mixture characteristic of fuel and fresh air is satisfactory in injection of fuel in the inlet stroke. Accordingly, the ratio of the exhaust stroke and the inlet stroke is changed in accordance with the internal EGR rate, so that the mixture having the satisfactory vaporization of fuel and the satisfactory mixture characteristic of fresh air and fuel can be formed irrespective of the internal EGR rate. Consequently, imperfect combustion can be suppressed and improvement in performance of fuel consumption and reduction in emissions can be realized over the broad internal EGR rate. Further, a device or the like for forming swirl is not required and the cost can be reduced.

Other objects, features and advantages of the invention will become apparent from the following description of the embodiments of the invention taken in conjunction with the accompanying drawings.

### BRIEF DESCRIPTION OF THE DRAWINGS

FIG. 1 schematically illustrates an internal combustion engine to which a fuel injection apparatus for an internal combustion engine according to an embodiment of the present invention is applied;

FIG. 2 shows examples of opening and closing timings of inlet and exhaust valves using movable valves and (1) shows an example having no OIL, (2) and (3) examples having plus O/L and (4) and (5) examples having minus O/L;

FIG. 3 is a diagram showing fuel injection timing in the embodiment of the present invention;

FIG. 4 is a graph showing an example of the relationship of an internal EGR rate and an injection ratio ε in the inlet stroke in the embodiment of the present invention;

FIG. 5 is a flow chart showing a decision procedure of the injection timing in the embodiment of the present invention;

FIG. 6 shows the behavior of combustion gas, fresh air and fuel within the engine upon injection in the exhaust stroke and (1) shows the behavior in the latter period of the exhaust stroke, (2) the behavior in the early period of the inlet stroke, and (3) the behavior in the middle period of the inlet stroke;

FIG. 7 shows the behavior of combustion gas, fresh air and fuel within the engine upon injection in the inlet stroke and (1) shows the behavior in the latter period of the exhaust stroke, (2) the behavior in the early period of the inlet stroke, and (3) the behavior in the middle period of the inlet stroke;

FIG. 8 shows examples of the relationshipship of the internal EGR rate and the injection ratio ε in the inlet stroke in the embodiment of the present invention;

FIG. 9 is a graph showing an example of the relationshipship of a valve overlap amount and the internal EGR rate;

FIG. 10 shows examples of the relationshipship of the valve overlap amount and the injection ratio ε in the inlet stroke in the embodiment of the present invention;

FIG. 11 is a graph showing an example of the relationshipship of an ignition timing advance degree and the internal EGR rate; and

FIG. 12 is a graph showing an example of the relationshipship of the ignition timing advance degree and the injection ratio ε in the inlet stroke in the embodiment of the present invention.

### DESCRIPTION OF THE EMBODIMENTS

Two embodiments of a fuel injection apparatus of the present invention are now described in detail with reference to the accompanying drawings.

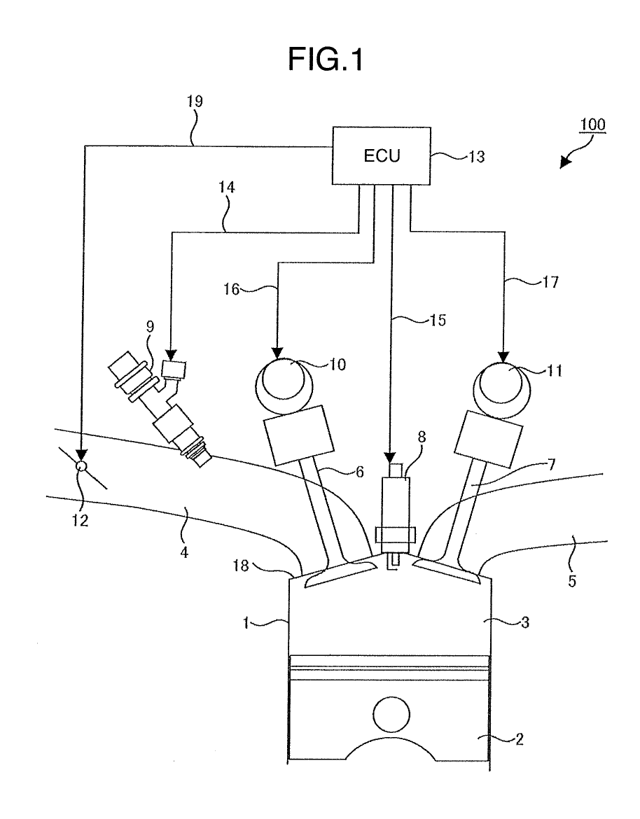

FIG. 1 illustrates an internal combustion engine according to a first embodiment of the present invention.

An internal combustion engine 100 includes a cylinder 1, a cylinder head 18 and a piston 2 inserted into the cylinder 1, and a combustion chamber 3 is formed in the cylinder 1. An inlet port 4 and an exhaust port 5 formed in the cylinder head 18 are opened in the combustion chamber 3 and an inlet valve 6 and an exhaust valve 7 which open and close the opened parts are disposed in the cylinder head 18. The opening timing of the inlet valve 6 can be changed by a valve timing control mechanism (hereinafter abbreviated to VTC) 10. Further, the opening timing of the exhaust valve 7 can be changed by a valve timing control mechanism (VTC) I1.

A fuel injection valve 9 is disposed in the inlet port 4. The injection direction of spray fuel injected from the fuel injection valve 9 is directed toward the inlet valve 6. The shape of a nozzle of the fuel injection valve and the fuel injection pressure are defined so that the diameter of droplets of spray fuel injected from the fuel injection valve 9 is made smaller sufficiently (for example, the Sauter mean diameter is about 20 to 50 μm). An ignition plug 8 is disposed at the upper middle part of the combustion chamber 3. A throttle valve 12 for adjusting an amount of air flowing into the combustion chamber 3 is disposed upstream of the inlet port 4.

An engine control unit (hereinafter abbreviated to ECU) 13 includes a microcomputer and a read-only memory (ROM) as its main components and executes an engine control program stored in the ROM. The ignition timing is determined by sending an ignition timing command 15 to the ignition plug 8. The opening and closing valve timings of the inlet valve 6 are determined by sending a phase crank angle command 16 to the VTC 10. The opening and closing valve timings of the exhaust valve 7 are determined by sending a phase crank angle command 17 to the VTC 11. The fuel injection timing and the injection period are determined by sending an injection timing command 14 to the fuel injection valve 9. The fuel injection valve 9 and the ECU 13 are configured so that injection can be made at least once in the exhaust stroke and at least once in the inlet stroke during one cycle and the respective injection periods in the exhaust stroke and the inlet stroke can be set independently.

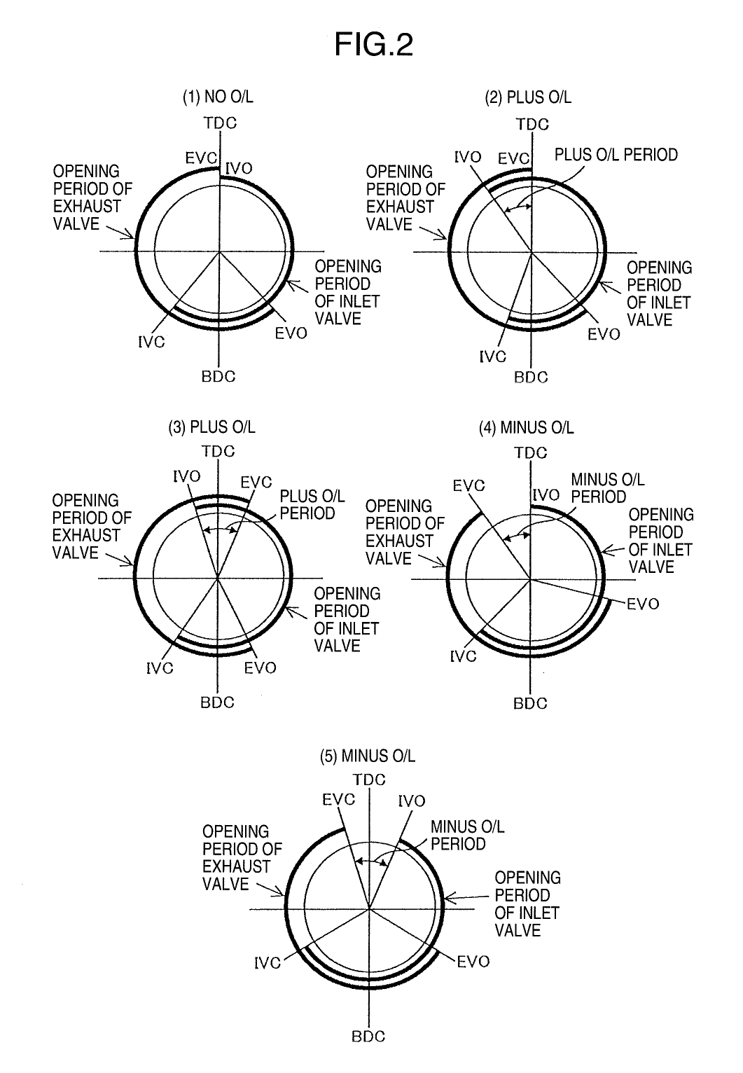

Referring now to FIG. 2, the timings of the inlet valve and the exhaust valve set by the VTC's 10 and 11 on the condition that the engine is operated at partial load are described. (1) of FIG. 2 shows that the closing valve timing of the exhaust valve (hereinafter abbreviated to EVC) and the opening valve timing of the inlet valve (hereinafter abbreviated to IVO) are set to be identical and shows an example of setting in which overlap of the opening valve period of the exhaust valve and the opening valve period of the inlet valve, that is, the so-called valve overlap (hereinafter abbreviated to O/L) is not present.

(2) and (3) of FIG. 2 show examples of setting in which the opening valve period of the exhaust valve and the opening valve period of the inlet valve are overlapped partially, that is, the so-called plus O/L is present. (2) shows an example that the IVO is angularly advanced before the top dead center (hereinafter abbreviated to TDC) to set the plus O/L and (3) shows an example that the IVO is angularly advanced before the TDC and the EVC is angularly delayed behind the TDC to set the plus O/L. Further, although not shown, the plus O/L can be set even when the IVO is fixed at the position where O/L is not present and only the ECV is angularly delayed.

(4) and (5) of FIG. 2 show examples of setting in which the closing valve period of the exhaust valve and the closing valve period of the inlet valve are overlapped partially, that is, the so-called minus O/L is present. (4) shows an example that the EVC is angularly advanced before the TDC to set the minus O/L and (5) shows an example that the EVC is angularly advanced before the TDC and the IVO is angularly delayed behind the TDC to set the minus O/L. Further, although not shown, the minus O/L can be set even when the EVC is fixed at the position where O/L is not present and only the IVC is angularly delayed.

As described above, the plus O/L is set to thereby blow combustion gas in the exhaust port into the inlet port through the combustion chamber within the plus O/L period. This reason is that pressure in the inlet port is equal to the atmospheric pressure by a diaphragm of the throttle valve at partial load, whereas pressure in the exhaust port is substantially equal to the atmospheric pressure and is higher than the pressure in the inlet port. The blown combustion gas is re-sucked into the combustion chamber within the inlet stroke and the combustion chamber is filled with the combustion gas as EGR gas.

Further, the minus O/L is set, so that part of the combustion gas is left in the combustion chamber without exhausting it and blown into the inlet port just after IVO. The blown combustion gas is re-sucked into the combustion chamber within the inlet stroke and the combustion chamber is filled with the combustion gas as EGR gas.

The amount of EGR gas with which the combustion chamber is filled is expressed by the internal EGR rate defined by expression 1.

$$Internal EGR rate = \frac{Mass of Residual Gas in Cylinder}{Mass of Whole Gas in Cylinder} \qquad ( Expression 1 )$$

The phase crank angle commands 16 and 17 are sent to the inlet VTC 10 and the exhaust VTC 11 by the ECU 13, respectively, to set the opening valve periods of the inlet valve 6 and the exhaust valve 7 to be equal to plus O/L or minus O/L, so that the internal EGR rate can be increased as compared with the case where O/L is not present. Further, the more the plus O/L amount or minus O/L amount is, the more the internal EGR rate is. In other words, since the backflow period of combustion gas from the exhaust port is made longer when the plus O/L is increased, the backflow gas amount is increased and the internal EGR rate is enhanced. Further, when the minus O/L is increased, an amount of combustion gas confined in the combustion chamber is increased without discharging the combustion gas and accordingly the internal EGR rate is increased. Therefore, the phase crank angle commands sent from the ECU 13 to the inlet VTC 10 and the exhaust VTC 11 can be changed to thereby adjust the internal EGR rate.

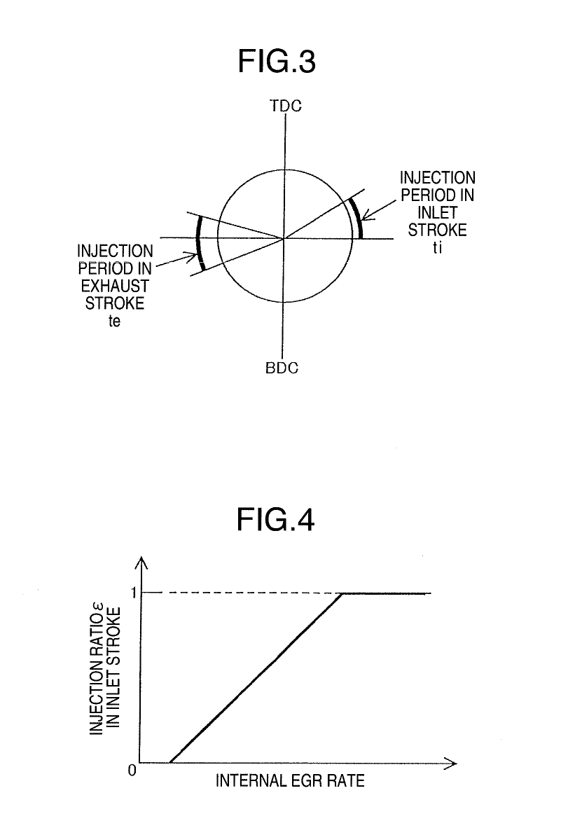

Referring now to FIGS. 3 to 5, a control method of fuel injection in the present invention is described. FIG. 3 shows an example of the injection timing of fuel at the time that the engine is burdened with partial load in the embodiment of the present invention. In this example, fuel is injected dividedly into the exhaust stroke and the inlet stroke. Here, the injection ratio ε in the inlet stroke is defined by the following expression 2 where the fuel injection periods in the exhaust and inlet strokees are te and ti, respectively.

$$ɛ = \frac{ti}{te + ti} \qquad ( Expression 2 )$$

FIG. 4 shows change of the injection ratio ε in the inlet stroke to the internal EGR rate. In the present invention, the injection ratio ε in the inlet stroke is changed by the internal EGR rate to set the injection ratio ε in the inlet stroke at the time that the internal EGR rate is high to be higher than the injection ratio ε in the inlet stroke at the time that the internal EGR rate is low. In other words, the injection timing command is sent from the ECU to the fuel injection valve so that as the internal EGR rate is higher, the injection period ti in the inlet stroke is made longer to increase the injection amount in the inlet stroke and the injection period te in the exhaust stroke is made shorter to reduce the injection amount in the exhaust stroke.

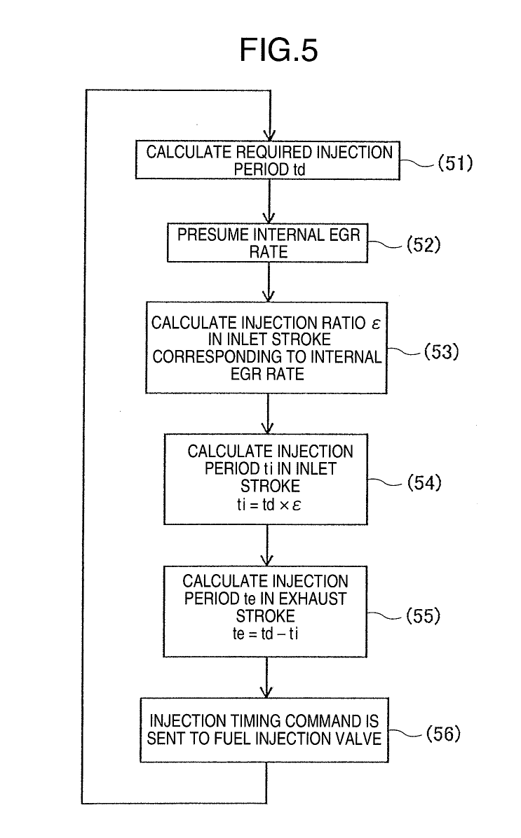

FIG. 5 is a flow chart showing the procedure of deciding the injection timing by the ECU 13 in the embodiment. First of all, in process (51), a required injection period td is calculated. A required fuel injection amount is presumed from the throttle aperture, the engine speed and the like and further the required injection period td is calculated from the required injection amount. Then, in process (52), the current internal EGR rate is presumed from OIL amount and the like. Next, in process (53), the injection ratio ε in the inlet stroke corresponding to the internal EGR rate is obtained. This injection ratio ε can be obtained by storing the relationshipship between the internal EGR rate and the injection ratio ε as shown in FIG. 4 in ROM of the ECU as a table beforehand and referring to the table, for example. Next, in process (54), the injection period ti in the inlet stroke is calculated by ti=td×ε. The injection period te in the exhaust stroke is calculated by te=td−ti in process (55). In process (56), the injection timing command is sent to the fuel injection valve, so that fuel injection is performed during the injection period te in the exhaust stroke and during the injection period ti in the inlet stroke.

Next, operation and effects of the embodiment are described.

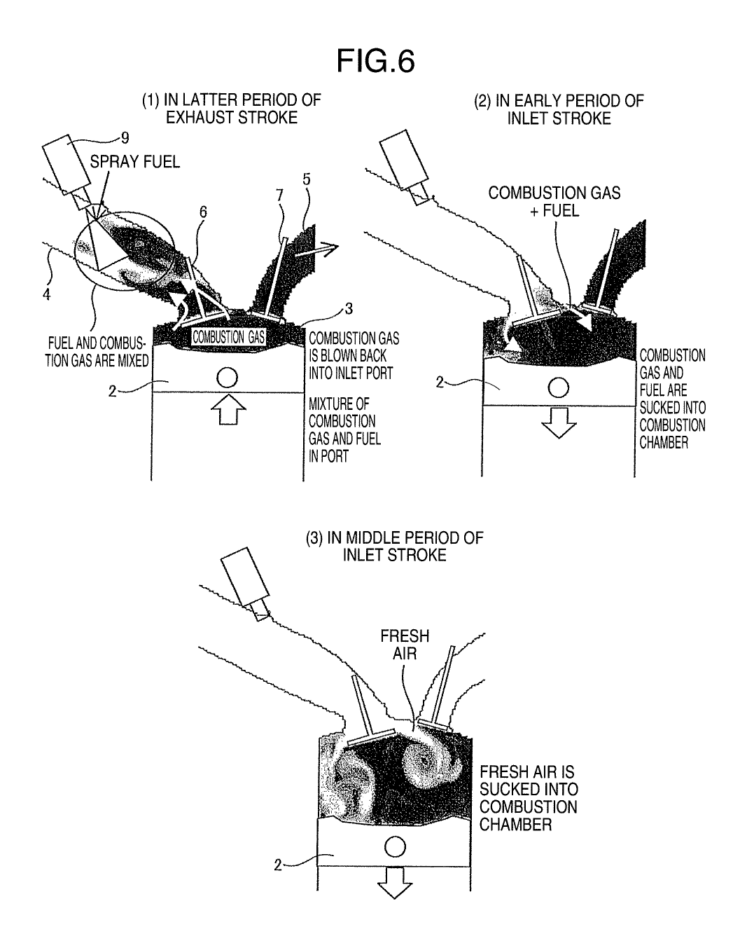

FIG. 6 schematically illustrates the behavior of combustion gas, fuel and fresh air in case where fuel is injected in the exhaust stroke. (1) of FIG. 6 shows the behavior in the latter period of the exhaust stroke, (2) the behavior in the early period of the inlet stroke and (3) the behavior in the middle period of the inlet stroke. Further, in FIG. 6, the condition of plus O/L is assumed, so that IVO is set before TDC of the exhaust stroke and EVC is set at TDC of the exhaust stroke. Consequently, the condition that the EGR rate is higher as compared with the case where O/L is not present is assumed.

Fuel is injected from the fuel injection valve 9 into the inlet port 4 within the exhaust stroke so that injection end timing is set at 70° CA (Crank Angle) before TDC of the exhaust stroke, for example. Since the flow of gas is not almost produced in the inlet port just after injection, spray fuel reaches the vicinity of the inlet valve by its accomplishment force in the latter period of the exhaust stroke (near the TDC of the exhaust stroke). Near the TDC of the exhaust stroke, the inlet valve 6 is opened before the TDC of the exhaust stroke, so that fuel gas in the combustion chamber 3 is blown into the inlet port 4. The fuel gas blown into the inlet port collides with the spray fuel in the inlet port. Since the fuel gas is high temperature, the spray fuel is vaporized rapidly and the mixture of the vaporized fuel and the combustion gas is accelerated in the inlet port ((1) of FIG. 6).

In the early period of the inlet stroke, the piston goes down, so that the mixture of combustion gas and fuel in the inlet port is sucked into the combustion chamber ((2) of FIG. 6).

Continuously, fresh air existing upstream of the inlet port is sucked into the combustion chamber in the middle period of the inlet stroke ((3) of FIG. 6).

As described above, in the injection of the exhaust stroke, after the mixture of combustion gas and fuel is first sucked, the fresh air is sucked and accordingly the mixture time of fuel and fresh air is made shorter as compared with the mixture time of fuel and combustion gas. That is, fuel is mixed with EGR gas satisfactorily but mixture of fuel and oxygen is suppressed. Since the EGR gas contains N₂ and CO₂ as its main components, the concentration of oxygen around the fuel mixed with EGR gas is reduced. Accordingly, when injection in the exhaust stroke is performed in case where the internal EGR rate is high, oxygen does not spread sufficiently around the fuel and mixture apt to produce imperfect combustion due to a shortage of oxygen is formed. On the other hand, the period from injection to ignition can be made long in injection of the exhaust stroke and accordingly there is a merit that vaporization of fuel can be accelerated.

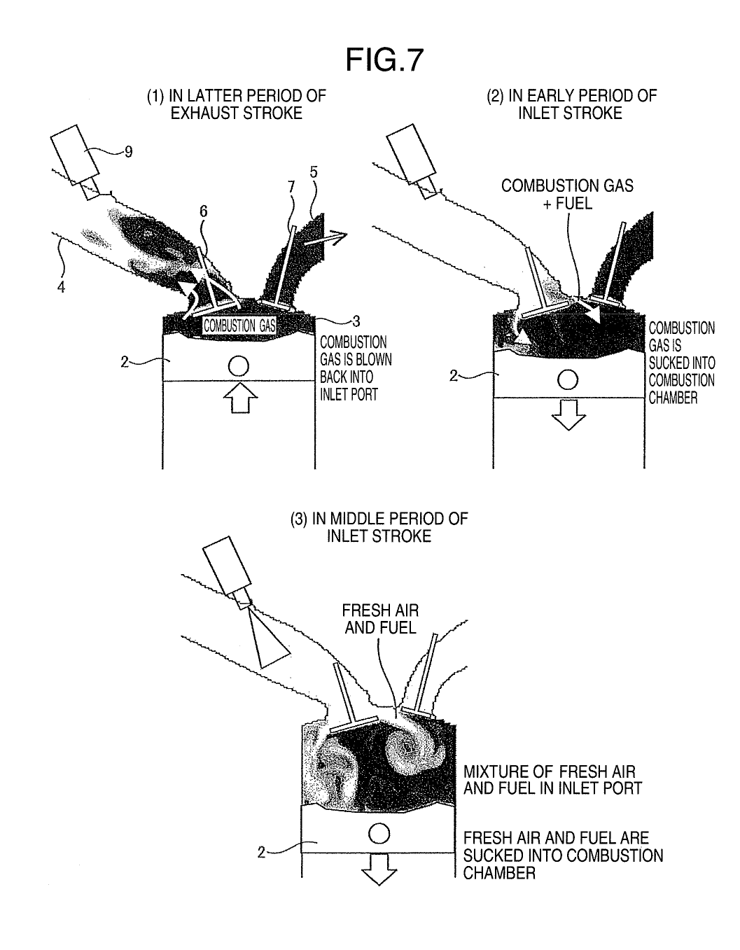

FIG. 7 schematically illustrates the behavior of combustion gas, fuel and fresh air in case where fuel is injected in the inlet stroke. (1) of FIG. 7 shows the behavior in the latter period of the exhaust stroke, (2) the behavior in the early period of the inlet stroke and (3) the behavior in the middle period of the inlet stroke. Further, in FIG. 7, the condition of plus O/L is assumed, so that IVO is set before TDC of the exhaust stroke and EVC is set at TDC of the exhaust stroke. Consequently, the condition that the EGR rate is higher as compared with the case where O/L is not present is assumed.

In the latter period of the exhaust stroke (near TDC), since the inlet valve 6 is opened before TDC of the exhaust stroke, the combustion gas in the combustion chamber 3 is blown back into the inlet port 4 ((1) of FIG. 7).

In the early period of the inlet stroke, since the piston goes down, the combustion gas in the inlet port is sucked into the combustion chamber ((2) of FIG. 7).

Continuously, fuel is injected from the fuel injection valve 9 into the inlet port 4 in the inlet stroke. Here, the injection end timing is set at 90° CA after TDC of the exhaust stroke, for example. The injected fuel is mixed with fresh air in the inlet port and the mixture of fresh air and fuel is sucked into the combustion chamber ((3) of FIG. 7).

As described above, in the injection of the inlet stroke, after the combustion gas is first sucked, the mixture of fresh air and fuel is sucked and accordingly the mixture time of fuel and fresh air is made longer as compared with the mixture time of fuel and combustion gas. That is, fuel is mixed with fresh air satisfactorily but mixture of fuel and EGR gas is suppressed. Accordingly, when the injection in the inlet stroke is performed, oxygen spreads sufficiently around fuel even when the internal EGR rate is high and mixture difficult to produce imperfect combustion due to a shortage of oxygen is formed. On the other hand, the period from injection to ignition can be made shorter in injection of the inlet stroke as compared with that in the exhaust stroke and accordingly there is a demerit that vaporization of fuel is liable to be insufficient. Particularly, when the internal EGR rate is low, the temperature in the combustion chamber from the inlet stroke to the compression process is lower as compared with the case where the internal EGR rate is high and accordingly a shortage of vaporization of fuel is liable to occur. The shortage of vaporization of fuel causes deterioration in emissions and fuel consumption.

As described above, there are the merit and the demerit in the injection of the exhaust and inlet strokees. That is, in the injection of the exhaust stroke, when the internal EGR is high, the mixture of fuel and EGR gas is accelerated and imperfect combustion is liable to be produced, whereas even when the internal EGR rate is low and the temperature in the combustion chamber is low, fuel is apt to be vaporized. Further, in the injection of the inlet stroke, when the internal EGR rate is low, the shortage of vaporization of fuel is liable to occur due to reduction in the temperature in the combustion chamber, whereas when the internal EGR is high, the mixture of fuel and fresh air is accelerated and imperfect combustion is difficult to occur. Accordingly, the ratio of injection of the exhaust stroke and injection of the inlet stroke is made proper in accordance with the internal EGR rate, so that the mixture that vaporization of fuel is apt to be made and imperfect combustion due to EGR gas is difficult to occur can be formed. Concretely, when the internal EGR rate is low, the ratio of injection in exhaust stroke is increased to thereby improve the vaporization of fuel, whereas when the EGR rate is high, the ratio of injection in inlet stroke is increased, so that imperfect combustion by EGR gas is difficult to occur. Consequently, the mixture optimum to combustion can be always formed irrespective of the internal EGR rate, so that effects such as improvement in efficiency of fuel consumption of the engine and reduction in emissions can be attained.

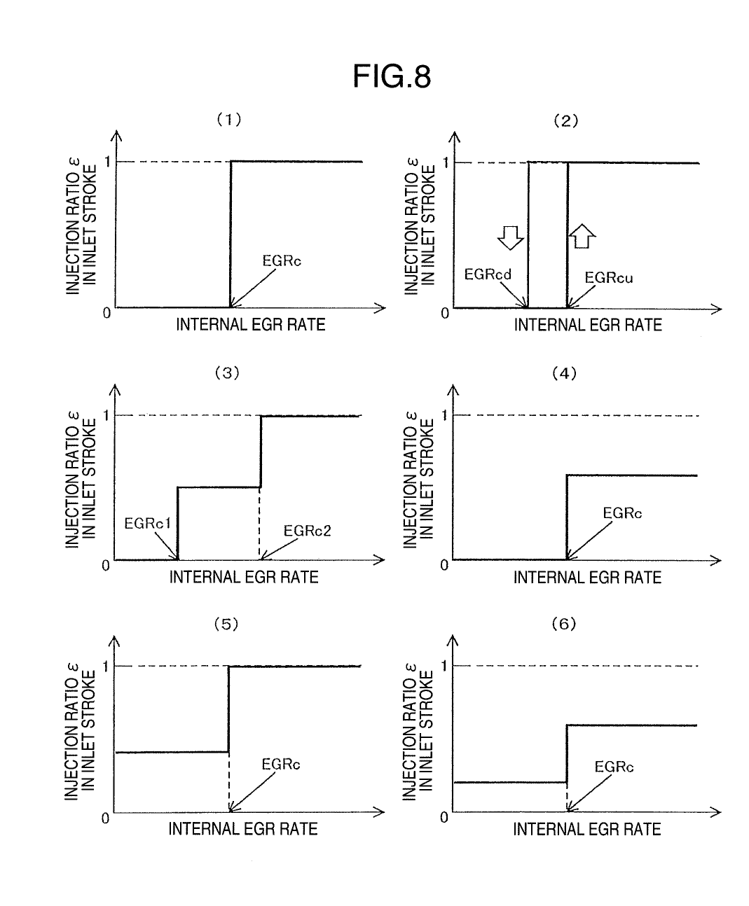

The changing method of the injection ratio ε in the inlet stroke to the internal EGR rate is not limited to the example shown in FIG. 4 and various methods can be considered. FIG. 8 shows other examples of the changing method of the injection ratio ε in the inlet stroke to the internal EGR rate. (1) of FIG. 8 shows an example in which when the internal EGR rate is smaller than a predetermined EGRc, only injection in the exhaust stroke is made while the injection ratio ε is set to be equal to zero and when the internal EGR rate is larger than or equal to the EGRc, only injection in the inlet stroke is made while the injection ratio ε is set to be equal to 1. This method has the merit that a control program for injection is simple and a memory size for the program is smaller as compared with the method shown in FIG. 4. Further, in this method, since it is not necessary to divide the injection into the exhaust stroke and the inlet stroke, there is also the merit that the requirement for the minimum flow rate (dynamic range) of the fuel injection valve and the operation speed of opening and closing valves is moderate and the cost of the fuel injection valve can be reduced.

In the method shown by (1) of FIG. 8, it is apprehended that when the internal EGR rate is varied subtly near the EGRc, the injection in the exhaust stroke and the injection in the inlet stroke are switched at a short period and the operability of engine is deteriorated. Accordingly, as shown by (2) of FIG. 8, EGRcu that is an internal EGR rate at the time that the injection in the exhaust stroke is changed to the injection in the inlet stroke when the internal EGR rate is increased is made larger than EGRcd that is the internal EGR rate at the time that the injection in the inlet stroke is changed to the injection in the exhaust stroke when the internal EGR rate is reduced, so that the hysteresis characteristic can be formed to thereby prevent deterioration in operability of the engine.

In the method shown by (3) of FIG. 8, the injection ratio ε in the inlet stroke is switched to have values in three stages to the internal EGR rate. When the internal EGR rate is smaller than a predetermined EGRc1, injection is made only in the exhaust stroke while the injection ratio ε is set to be equal to zero (ε=0) and when the internal EGR rate is larger than or equal to the EGRc1 and is smaller than EGRc2, the injection in the exhaust stroke and the injection in the inlet stroke are made while the injection ratio ε is set to be 0<ε<1. Further, when the internal EGR rate is larger than or equal to the EGRc2, only the injection in the inlet stroke is made while the injection ratio ε is set to be ε=1. This method has the merit that the control program of injection is simpler and the memory size for the program is smaller as compared with the method shown in FIG. 4. Moreover, when the internal EGR rate is about middle (EGRc1<internal EGR rate<EGRc2), injection is made in both of the exhaust stroke and the inlet stroke, so that satisfactory vaporization of fuel in the injection of the exhaust stroke and satisfactory mixture of fuel and air in the injection of the inlet stroke can be utilized to form the mixture. Accordingly, the efficiency of fuel consumption can be improved and emissions can be reduced as compared with the methods shown in (1) and (2) of FIG. 8. Further, even in the method shown in (3) of FIG. 8, the hysteresis characteristic can be formed similarly to the method shown in (2) of FIG. 8, so that deterioration in operability of the engine can be prevented. In the method shown in (3) of FIG. 8, the injection ratio ε in the inlet stroke is switched to have values in three stages to the internal EGR rate, although it is not limited to have values in three stages and it may be switched to have values in more stages. As the number of stages is increased, the injection time in the exhaust stroke or the inlet stroke is made shorter when injection is made dividedly into the exhaust stroke and the inlet stroke. That is, as the number of stages is increased, the requirement for the minimum injection amount (dynamic range) to the fuel injection valve is more severe and the cost is increased. On the other hand, as the number of stages is increased, more minute injection control cab be made to the internal EGR rate and satisfactory mixture can be formed. Consequently, as the number of stages is increased, effects of improvement in efficiency of fuel consumption and reduction in emissions are increased. Accordingly, the number of stages can be selected properly while considering the effects of reduction in cost, fuel consumption and exhaust emission control.

In the method shown in (1) to (3) of FIGS. 4 and 8, when the internal EGR rate is minimum, only injection in the exhaust stroke is made while the injection ratio ε is set to be equal to 0 (ε=0) and when the internal EGR rate is maximum, only injection in the inlet stroke is made while the injection ratio ε is set to be equal to 1 (ε=1), although the present invention is not limited thereto. As shown in (4) of FIG. 8, injection may be made in both of the exhaust stroke and the inlet stroke while a value of the injection ratio ε is set to be 0<ε<1 when the internal EGR rate is maximum. Further, as shown in (5) of FIG. 8, injection may be made in both of the exhaust stroke and the inlet stroke while a value of the injection ratio ε is set to be 0<ε<1 when the internal EGR rate is minimum. Moreover, as shown in (6) of FIG. 8, injection may be made in both of the exhaust stroke and the inlet stroke while a value of the injection ratio ε is set to be 0<ε<1 in both cases where the internal EGR rate is minimum and maximum. The simplicity in vaporization of fuel and mixture of combustion gas and fresh air is varied depending on characteristic of fuel injection valve, shape of inlet port and operation conditions of engine (load, engine speed and the like) variously and accordingly the optimum injection ratio ε in the inlet stroke for minimum or maximum internal EGR rate may be decided in accordance with the kind and the operation conditions of the engine.

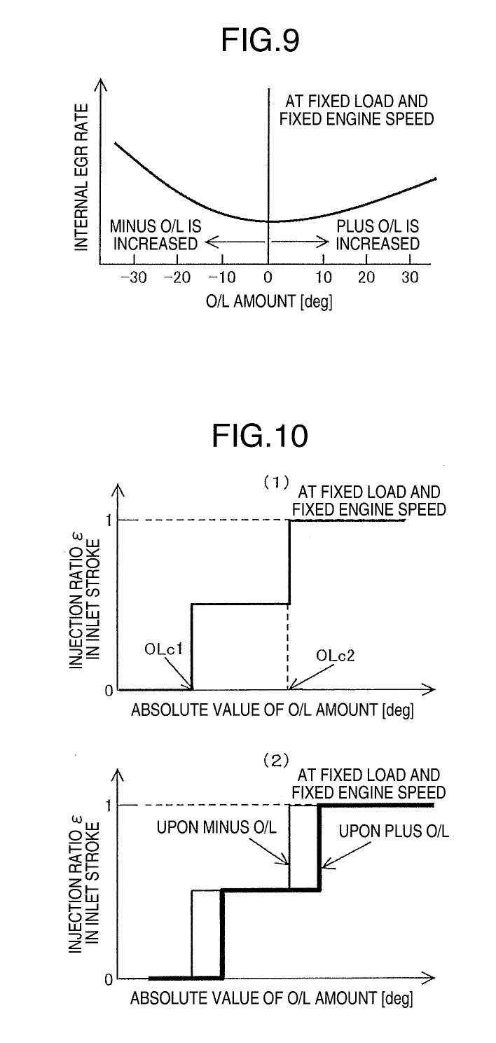

In the embodiment described above, the injection ratio ε in the inlet stroke is decided according to the internal EGR amount, although the internal EGR amount has the interrelationship with OIL amount and accordingly the injection ratio ε in the inlet stroke may be decided to the OIL amount. FIG. 9 shows an example showing change of the internal EGR rate to the O/L amount. As shown in FIG. 9, the internal EGR rate is increased for both of minus O/L and plus OIL as an absolute value of O/L is increased on the condition that the engine is operated under a fixed load and a fixed engine speed. Since the blowing period of combustion gas from the exhaust port is made long when plus O/L is increased, the amount of blown gas is increased and the internal EGR rate is increased. When minus OIL is increased, the amount of combustion gas confined in the combustion chamber without exhaust is increased and accordingly the internal EGR rate is increased.

Since there is the interrelationship as shown in FIG. 9 between the O/L amount and the internal EGR rate, the injection ratio ε in the inlet stroke may be decided in accordance with an absolute value ‥O/L| of the O/L amount as shown in (1) of FIG. 10. In an example shown in (1) of FIG. 10, when the absolute value |O/L| is smaller than OLc1 (|O/L|<OLc1), injection is made only in the exhaust stroke while the injection ratio ε in the inlet stroke is set to be equal to 0 (ε=0). When OLc1≦|O/L|<OLc2, injection is made in both of the exhaust stroke and the inlet stroke while the injection ratio ε in the inlet stroke is set to be 0<ε<1. When |O/L|≧OLc2, injection is made only in the inlet stroke while the injection ratio ε is set to be equal to 1 (ε=1).

Generally, even when the O/L amount is the same in minus O/L and plus O/L, the internal EGR rate thereof is different as shown in FIG. 9. This reason is that gas blown into port is fed only from the combustion chamber in minus O/L, whereas gas blown into port is fed from the exhaust port through the combustion chamber in plus O/L. That is, the simplicity in blowing of combustion gas into inlet port is different depending on difference of route and the internal EGR rate is different even for the same O/L amount in minus O/L and plus O/L. Accordingly, as shown in (2) of FIG. 10, the injection ratio ε in the inlet stroke is changed for minus O/L and plus O/L, so that the interrelationship between O/L amount and actual internal EGR rate is increased and the more optimum injection ratio ε in the inlet stroke can be decided to O/L amount.

Further, the changing method of the injection ratio ε in the inlet stroke to O/L amount is not limited to the method shown in FIG. 10 and various methods in which the internal EGR rate in the methods shown in (1) to (6) of FIGS. 4 and 8 is replaced by O/L amount are considered.

Moreover, since the internal EGR amount has the interrelationship with an ignition timing advance degree, the injection ratio ε in the inlet stroke may be decided to the ignition timing advance degree instead of the internal EGR rate or O/L amount.

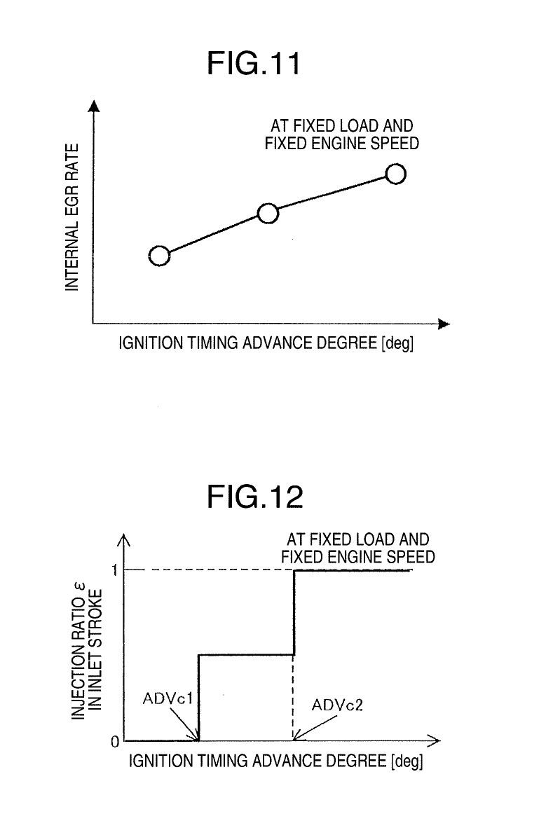

FIG. 11 shows an example of the relationship between the ignition timing advance degree and the internal EGR rate in the best combustion point (MBT). When the internal EGR rate is increased, the combustion speed is reduced and accordingly the ignition timing advance degree at MBT is increased under a fixed load and the a fixed engine speed.

Since there is the satisfactory interrelationship between the internal EGR amount and the ignition timing advance degree, the injection ratio ε in the inlet stroke may be decided in accordance with the ignition timing advance degree (ADV) as shown in FIG. 12. In an example shown in FIG. 12, when ADV<ADVc1, injection is made only in the exhaust stroke while the injection ratio ε in the inlet stroke is set to be equal to 0 (ε=0). When ADVc1≦ADV<ADVc2, injection is made both in the exhaust stroke and the inlet stroke while the injection ratio ε in the inlet stroke is set to be 0<ε<1. When ADV≧ADVc2, injection is made only in the inlet stroke while the injection ratio ε is set to be equal to 1 (ε=1).

Further, the changing method of the injection ratio ε in the inlet stroke to O/L amount is not limited to the method shown in FIG. 12 and various methods in which the internal EGR rate in the methods shown in (1) to (6) of FIGS. 4 and 8 is replaced by the ignition timing advance degree are considered.

As described above, the embodiment of the present invention has been described, although the present invention is not limited to the embodiment and various modifications and variations in the design may be made without departing from the spirit and the scope of the invention described in the Claims.

As can be understood from the above description, according to the present invention, fuel and air can be mixed sufficiently even on condition that the internal EGR rate is high and accordingly imperfect combustion due to a shortage of oxygen can be prevented. Further, even on condition that the internal EGR rate is low, satisfactory vaporization performance of fuel can be attained. Consequently, improvement in efficiency of fuel consumption and reduction in emissions of the engine can be attained over the broad internal EGR rate. Moreover, the present invention does not require addition of a device for producing swirl or the like in the combustion chamber and can be realized by changing the injection timing of fuel, so that the cost can be suppressed to be low.

It should be understood by those skilled in the art that although the present disclosure has been described with reference to example embodiments, those skilled in the art will recognize that various changes and modifications may be made in form and detail without departing from the spirit and scope of the claimed subject matter.

1. A fuel injection apparatus for an internal combustion engine which injects fuel into an inlet port, comprising:
a controller, when a fuel injection period in an exhaust stroke is te, a fuel injection period in an inlet stroke is ti and an injection ratio in the inlet stroke is ε=ti/(te+ti), configured to generate a control signal to make a value of the injection ratio ε in case where a valve overlap period is long larger than a value of the injection ratio ε in case where the valve overlap period is short under an engine operation condition of identical engine speed.

2. A fuel injection apparatus for an internal combustion engine which injects fuel into an inlet port, comprising:
a controller configured to generate a control signal to inject fuel in an exhaust stroke when a valve overlap period is shorter than a predetermined period and to inject fuel in an inlet stroke when the valve overlap period is longer than the predetermined period under an engine operation condition of identical engine speed.

3. The fuel injection apparatus for an internal combustion engine according to claim 1, wherein
relationshipships of the fuel injection ratio ε in the inlet stroke to the valve overlap period in a case of plus overlap period and a case of minus overlap period are different from each other.

4. A fuel injection apparatus for an internal combustion engine which injects fuel into an inlet port, comprising:
a controller, when a fuel injection period in an exhaust stroke is te, a fuel injection period in an inlet stroke is ti and an injection ratio in the inlet stroke is ε=ti/(te+ti), configured to generate a control signal to make a value of the injection ratio ε in case where ignition timing is advanced larger than a value of the injection ratio ε in case where the ignition timing is retarded under an engine operation condition of identical engine speed.
